(19) United States
(12) Patent Application Publication
(10) Pub. No.: US 2008/0115108 A1
(43) Pub. Date: May 15, 2008

(54) Microcomputer having security function for memory access and debugging method of the same

(75) Inventor: Takahisa Gunji, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/979,796

(22) Filed: Nov. 8, 2007

(30) Foreign Application Priority Data
Nov. 9, 2006 (JP) 2006-304228

(51) Int. Cl. G06F 9/44

(52) U.S. Cl. 717/124

(57) ABSTRACT

A microcomputer includes a first memory which stores a program to operate the microcomputer; and a second memory which stores one of a first data and a second data. The first data indicates approval to perform a debug of the microcomputer without checking the program and a bit inputted from outside of the microcomputer. The second data indicates approval to perform a check of the program and the bit.

### BACKGROUND OF THE INVENTION

1. Field of the Invention

The present invention relates to a microcomputer capable of security assurance for approval to read programs written to a memory in debugging of the microcomputer and a program debugging method.

2. Description of Related Art

In program development of a microcomputer, through connection between a microcomputer and a host PC such as a personal computer, the degree of program completeness is increased by debugging such as checking a produced program for problems or modifying it. In the debugging, a memory in which the program is stored must be read. That is, in the debugging, since a program stored in the memory can be read, there has been a problem in that the program of the microcomputer leaks to a malicious third party or the like.

During debugging, to prevent a program of a microcomputer from leaking to third parties, a method of reading and debugging a program within the microcomputer only when access keys of the program match is described Patent Document 1.

FIG. 5 shows the configuration of on-chip debugging security described in Patent Document 1. The on-chip debugging means debugging a user board in a state in which the user board is mounted on a microcomputer.

A microcomputer 901 shown in FIG. 5 includes a peripheral I/O (Input/Output) 902, a CPU (Central Processing Unit) 903, a ROM (Read Only Memory) 904, a RAM (Random Access Memory) 905, a debugging function control circuit 906, a debugging IF (Interface) terminal 907, an internal bus 908 that connects these devices, a bus control circuit 909 that controls the internal bus, and an external bus terminal 910 connected to the bus control circuit. A debugging function control circuit 906 includes a resource access circuit 911 and a CPU control circuit 912 that are connected to the internal bus, a protect checking circuit 913 connected to the resource access circuit 911 and the CPU control circuit 912, an access key register 914 and a debugging IF input/output circuit 915 that are connected to the protect checking circuit 913.

JTAG-ICE (Joint Test Action Group In-Circuit Emulator) is used for debugging. An ICE is a device that includes a function to set and change system states of the microcomputer, a trace function to confirm execution states of the system, and a brake function to break program execution in specific points of a program. JTAG is a test standard of boundary scan test (BST: Boundary Scan Test), and an ICE having function of the boundary scan is referred to as JTAG-ICE. The JTAG-ICE is connected to the microcomputer 901 via the debugging IF terminal 907.

In the microcomputer 901, program readout during on-chip debugging of the ROM 904 is limited by the access key register 914 and a function limitation mode register 916. That is, the access key register 914 is stored with an access key read from the ROM 904 or RAM 905 to clear a function limitation mode of the protect checking circuit 913 describes later. The function limitation mode register 916 is stored with a value (hereinafter referred to a function limitation mode setting value) indicative of limiting a function to read data within the microcomputer (hereinafter referred to as a function limitation mode) and or a value (hereinafter referred to as a function limitation mode not-setting value).

The following describes a procedure for SECURITY ASSURANCE in reading a program from the ROM 904 in debugging. When a user inputs an access key by using JTAG-ICE, the inputted access key is sent to the protect checking circuit 913. Next, In the protect checking circuit 913, a security code set previously in the access key register 914 is compared with a key sent from a host PC 917. As a result of the comparison, when the security code and the key sent from the host PC 917 match, the function limitation mode register 916 is set to the function limitation mode not-setting value. That is, processing such as reading, execution, and updating for the program stored in the ROM 904 can be performed through the resource access circuit 91I/Or the CPU control circuit 912. On the other hand, as a result of the comparison, when the security code and the key sent from the host PC 917 do not match, the function limitation mode register 916 is set to the function limitation mode setting value. That is, processing such as reading, execution, and updating for the program stored in the ROM 904 cannot be performed.

However, in on-chip debugging security of a microcomputer described in Patent Document 1, to assure security, the security of a microcomputer must be cleared using security codes during debugging. That is, security codes as well as programs must also be managed. As a result, there has been a problem in that the user must manage more items and the number of man-hours for debugging operations during debugging increases.

In Patent Document 2, a method is described which reads data stored in ROM while assuring the security of the data stored in the ROM, based on match or mismatch between the data stored in the ROM and inputted data without the user's using security codes. FIG. 6 shows a microcomputer used for the program readout method described in Patent Document 2. The microcomputer 920 shown in FIG. 6 includes a ROM 921, a ROM data latch circuit 922, a match detecting circuit 923, an input data latch circuit 924, an input circuit 925, a control circuit 926, and an output circuit 927. When power is applied to the microcomputer 920 in a test state, input data for comparison is inputted to the input circuit 925 and is outputted to the input data latch circuit 924. Data read from the ROM 921 is outputted to the ROM data latch circuit 922. Next, when the outputs of the ROM data latch circuit 922 and the input data latch circuit 924 match, the data of the ROM 921 can be read.
[Patent Document 1] Japanese Laid Open Patent Application No. 2003-186693
[Patent Document 2] Japanese Laid Open Patent Application Publication No. Hei2 (1990)-27050226

Recently, final products in which a microcomputer is mounted have become more advanced, and even after the final products have been put on the market, programs stored in the microcomputer may be sometimes updated to add functions. As products have more advanced functions and shorter life cycles, operation verification tests before product shipment cannot be sufficiently run, and in some cases, after their shipment, modification programs are distributed for bug modifications of programs stored in the microcomputer. In such a case, by mounting a rewritable nonvolatile memory in the microcomputer, programs are stored on the nonvolatile memory to provide for program updating for function addition and bug modifications.

Thus, a program stored in a nonvolatile memory is updated because of function addition, bug modification, and the like, and may be different between before and after product shipment. Furthermore, patterns of an updated program exist by the number of programs updates for function additions and bug modifications.

However, the microcomputer 920 of Patent Document 2 does not assume that such program updates may be performed plural times. That is, when the ROM 921 described in Patent Document 2 is a rewritable nonvolatile memory, and a program executed by the microcomputer is stored in the ROM 921, no description is made as for the case where the program stored in the ROM 921 may be rewritten.

In Patent Document 2, when a program stored in the ROM 921 must be debugged to analyze defects after product shipment, a program stored in the ROM 921 mounted in a product collected as a defective product, and data for comparison inputted from the input circuit 925 must match. However, as described previously, it is impossible to determine to what program the program stored in the ROM mounted in the product collected as a defective product has been updated. Therefore, all conceivable programs (source program for shipment and plural updated programs) are prepared, for all programs, the comparison operations must be performed until the comparisons result in match. In this case, when program updating is performed more frequently and there are more corresponding defective products, operation for clearing security for debugging becomes more complicated.

### SUMMARY OF THE INVENTION

A microcomputer of an aspect of the present invention has a nonvolatile memory which includes a storage area storing a program, and a central processing unit that executes the program. The microcomputer includes a debugging terminal for connecting a debugging machine used to debug the program, a memory for setting a debugging function that stores a debugging function setting value associated with a storage area, and a debugging determination unit that compares a part of the program stored in the storage area selected based on the debugging function setting value with data inputted from the debugging terminal, and based on a result of the comparison, determines whether to approve access from the outside.

A microcomputer of an other aspect of the present invention, includes, a first memory which stores a program to operate the microcomputer; and a second memory which stores one of a first data and a second data. The first data indicates to an acceptation of a debug of the microcomputer without checking the program and a bit inputted from outside of the microcomputer and the second data indicates to an acceptation of a check of the program and the bit.

In the present invention, it is determined whether to perform debugging by whether a part of program written to the memory of the microcomputer and a part of a program stored in an external device of the microcomputer match.

According to the present invention, even when a program used for security canceling is updated, security canceling for starting debugging can be performed without troublesome operations.

### BRIEF DESCRIPTION OF THE DRAWINGS

The above and other aspects, advantages and features of the present invention will be more apparent from the following description of certain exemplary embodiments taken in conjunction with the accompanying drawings, in which:

FIG. 1 is a block diagram showing a debugging system of a microcomputer of a first embodiment;

FIG. 2 is an operation flowchart showing operation during debugging of a microcomputer of a first embodiment;

FIG. 3 is a block diagram showing a debugging system of a microcomputer of a second embodiment;

FIG. 4 is an operation flowchart showing operation during debugging of a microcomputer of a second embodiment;

FIG. 5 is a block diagram showing a debugging system of a microcomputer of a related art; and

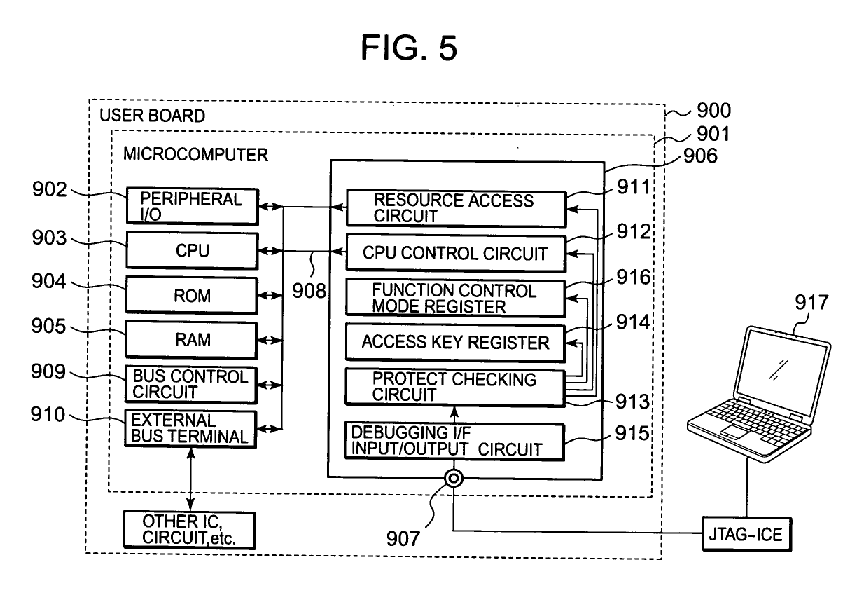

FIG. 6 is a schematic diagram showing the operation of a microcomputer of a related art.

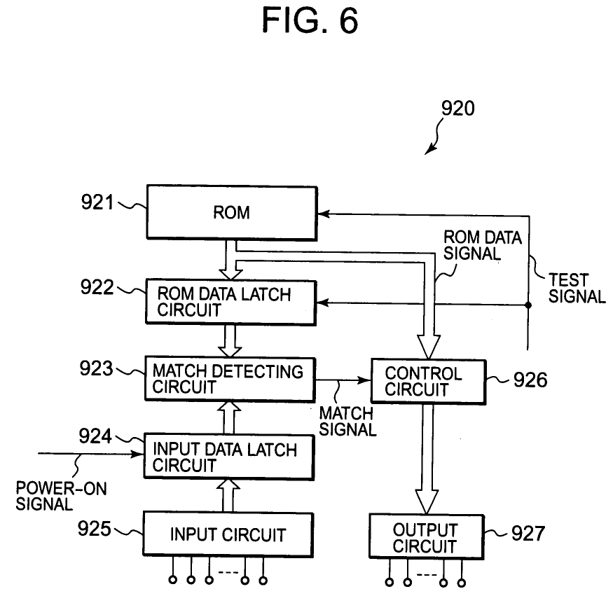

### DETAILED DESCRIPTION OF THE EXEMPLARY EMBODIMENT

### First Embodiment

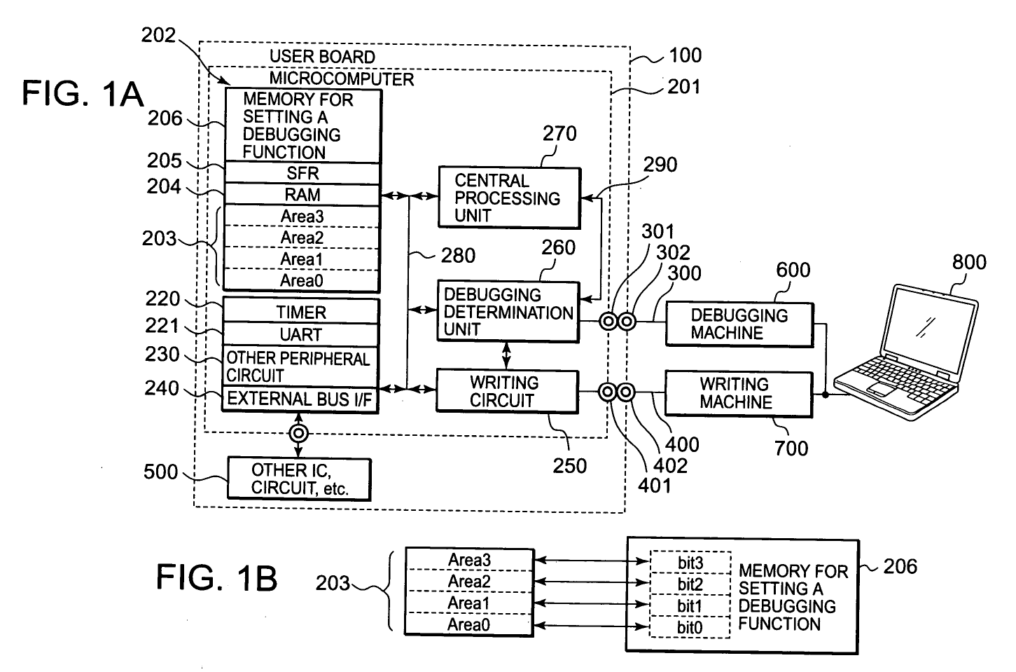

The following details a first embodiment with reference to the drawings. FIG 1A shows an overall configuration of a debugging system of a microcomputer of a first embodiment. As shown in FIG. 1A, a debugging system of the microcomputer of the first embodiment includes a microcomputer 201, a user board 100 having an IC 500 such as, e.g., a USB controller, a debugging machine 600 that has a program break function and the like, a writing machine 700, and an EWS (Engineering Workstation) personal computer 800 (hereinafter referred to as a host PC) that performs program debugging, program writing, and the like. The debugging machine 600 is connected to a connection terminal 302 formed on the user board 100, and is connected with the debugging determination unit 260 described later via a communication path for debugging 300. The writing machine 700 is connected to a connection terminal 402 formed on the user board 100, and is connected with a writing circuit 250 of the microcomputer 201 via a writing communication path 400 described later. The host PC 800 debugs a program stored in the microcomputer 201 via the debugging machine 600. It also writes a debugged program to the microcomputer 201 via the writing machine 700.

The microcomputer 201 includes a memory 202 to store programs and the like, a writing circuit 250 for writing a program to the memory 202, a debugging determination unit 260 that determines the approval of disapproval of debugging based on a result of comparison between a program stored in the memory 202 according to a value of a memory for setting a debugging function 206 described later and a program to be debugged that is stored in the host PC 800, and a central processing unit (CPU) 270 that executes a program. Additionally, the microcomputer 201 includes a timer 220 capable of interval interrupt, PWM (Pulse Width Modulation) output, and the like, a UART (Universal Asynchronous Receiver Transmitter) for communication 221, a circuit 230 having other peripheral functions, and an external bus I/F 240, which is an interfacing device for externally connecting an element to the microcomputer. Devices are mutually connected to the microcomputer 201. The CPU 270 and the debugging determination unit 260 are connected through a special bus 290. Furthermore, the microcomputer 201 includes connection terminals 301 and 401 and the like for connecting with the user board 100.

The memory 202 of the microcomputer 201 includes a rewritable nonvolatile memory 203 (hereinafter referred to as a nonvolatile memory), a RAM 204, an SFR (Special Function Register) 205, and a memory for setting a debugging function 206. The SFR 205 is a special function register that controls the timer 220, the UART 221, another peripheral circuit 230, and the like of the microcomputer 201. The RAM 204 holds data such as the results of operations by the microcomputer 201. The RAM 204 can be used to execute a program and temporarily saves data during program execution.

The nonvolatile memory 203 is a memory that stores a program and data of the microcomputer 201. As data of the nonvolatile memory 203, a program and the like are written by the writing circuit 250. When program updating is performed to add functions and modify bugs, the nonvolatile memory 203 is split into plural blocks to enable debugging. One program is divided into plural blocks before being stored. That is, parts of the programs are stored in plural blocks, respectively. A microcomputer designer can arbitrarily decide the size of a block of the nonvolatile memory 203.

The memory for setting a debugging function 206 stores a debug function setting value set for each of blocks of the nonvolatile memory 203. A debug function setting value is a value indicating whether to approve debugging.

The following describes the relationship between the nonvolatile memory 203 in FIG. 1B and the memory for setting a debugging function 206. A debugging function setting value corresponding to each block of the nonvolatile memory 203 is stored in the memory for setting a debugging function 206. That is, one program is stored separately in plural blocks of the nonvolatile memory 203, and a debugging function setting value corresponding to a part of the program stored in each block of the nonvolatile memory 203 is set and stored in the memory for setting a debugging function 206. Thereby, whether to approve debugging can be set for each of the blocks of the nonvolatile memory 203. Furthermore, parts of the program to be updated that are stored in the blocks of the nonvolatile memory 203 can be set not to be subjected to whether to approve debugging, so that even when the program has been updated, it can be debugged.

Since blocks of the nonvolatile memory 203 to be subjected to program updating are known in advance to the program designer, the user sets to zero the debugging function setting values of the memory for setting a debugging function 206 corresponding to blocks of the nonvolatile memory 203 that are to be not subjected to program updating. Thereby, parts of the program stored in blocks of the nonvolatile memory 203 that are to be subjected to program updating are not subjected to determination of the approval or disapproval of debugging. Therefore, debugging can be performed even when the program has been updated.

For example, in the first embodiment, a debugging function setting value stored in the memory for setting a debugging function 206 is set to zero when the approval or disapproval of debugging is determined by determining whether data stored in the nonvolatile memory 203, that is, parts of the program match parts of a program that correspond to parts of the program and are stored in the host PC 800 (hereinafter referred to as comparison data). The debugging function setting value is set to one when debugging is approved without comparing the comparison data stored in the host PC 800 with parts of the program stored in the nonvolatile memory 203.

That is, as described later, a debugging start signal is transmitted from the host PC 800 to the debugging determination unit 260. The debugging determination unit 260, to determine whether to approve debugging, reads debugging function setting values of the memory for setting a debugging function 206 that correspond to individual blocks (Areas 0 to 3) of the nonvolatile memory 203. When the debugging function setting value is one, debugging is approved with performing match determination. On the other hand, when the debugging function setting value is zero, match determination is performed by comparing comparison data stored in the host PC 800 with parts of the program stored in the blocks of the nonvolatile memory 203. In the match determination, it is confirmed that the comparison data stored by host PC 800 matches parts of the program stored in the nonvolatile memory 203. In all blocks of the nonvolatile memory 203, debugging is approved when parts of the stored program match the comparison data stored in the host PC 800.

In the first embodiment, the debugging determination unit 260 reads the debugging function setting values stored in the memory for setting a debugging function 206, according to their values, determines whether parts of the program stored in the nonvolatile memory 203 match comparison data that correspond to the program and is stored in the host PC 800, and determines the approval or disapproval of debugging. However, for example, the CPU 270 may also make the determination. Furthermore, in the first embodiment, When the debugging function setting value stored in memory for setting a debugging function 206 is zero, the approval or disapproval of debugging is determined by determining whether the comparison data stored in the host PC 800 matches parts of the program stored in the nonvolatile memory 203. When the debugging function setting value is one, debugging is approved without comparing the comparison data stored in the host PC 800 with parts of the program stored in the nonvolatile memory 203. When the debugging function setting value is one, program match determination is performed, while when the debugging function setting value is zero, debugging may be approved without performing program match determination.

From the above, in each block of the nonvolatile memory 203, when one is stored in the memory for setting a debugging function 206, the debugging determination unit 260 approves debugging without comparing parts of the program stored in the nonvolatile memory 203 with the comparison data sent from the host PC 800 via the debugging machine 600. On the other hand, when zero is stored in the memory for setting a debugging function 206, the debugging determination unit 260 compares parts of the program stored in the nonvolatile memory 203 with the comparison data sent from the host PC 800 via the debugging machine 600. When all blocks of the nonvolatile memory 203 match the comparison data sent from the host PC 800, debugging is immediately approved. As a result of program comparison, when the comparison does not match in at least one block, since the debugging determination unit 260 does not approve debugging, the host PC 800 cannot perform debugging. That is, with the program itself as security code for debugging, the comparison data stored in the host PC 800 is compared with parts of the program stored in the nonvolatile memory 203, and only when both match, the host PC 800 can perform debugging. When the programs do not match, since the host PC 800 cannot perform debugging, data stored in the RAM 204, the SFR 205, and the like of the microcomputer 201, and data indicating internal states of the CPU 270 can be prevented from leaking.

The following describes processes of microcomputer program development, program writing, and program debugging that are performed by a user by using the above-described microcomputer, and product shipment. First, a program is developed. That is, the user defines the operation of the microcomputer 201 to conform to a system created by the user. Then, the host PC 800 is used to perform coding (creation) of a program for the microcomputer.

Next, the coded program is written. The user transfers the coded program from the host PC 800 to the writing circuit 250 of the microcomputer 201 via the writing machine 700. The writing circuit 250 receives the program transmitted from the host PC 800, and writes the program sent from the host PC 800 to the nonvolatile memory 203 of the microcomputer 201. In the first embodiment, after elements such as the memory 202 and the debugging determination unit 260 are formed on the microcomputer 201, the program is written from the host PC 800 to the nonvolatile memory 203 via the writing machine 700 and the writing circuit 250. However, in the manufacturing process of the microcomputer 201 or example, the writing circuit may also be connected directly to the nonvolatile memory 203 to write a program without going through the host PC 800, and the like.

When a program is written to the nonvolatile memory 203, debugging function setting values stored in the memory for setting a debugging function 206 may be decided. That is, as described above, a debugging function setting value of one or zero is stored in the memory for setting a debugging function 206. During the program development and during the program debugging, since debugging functions are frequently used, preferably, a debugging function setting value of the memory for setting a debugging function 206 may be set to one. That is, during the program development and during the program debugging, without determining whether program parts stored in blocks of the nonvolatile memory 203 match comparison data sent from the host PC 800 via the debugging machine 600, it is desirable to immediately approve debugging on demand for debugging. Thereby, time for debugging operations can be shortened.

After the termination of program coding, writing of a part of a program stored in each block of the nonvolatile memory 203 of the microcomputer 201 is performed for all blocks. At this time, a debugging function setting value corresponding to each block of the nonvolatile memory 203 is set, and a debugging function setting value of zero or one is stored for each of the blocks. In the first embodiment, when a debugging function setting value is one, debugging is performed without making program comparison, and when a debugging function setting value is zero, program comparison is made. However, when a debugging function setting value is one, program comparison may be made, and when a debugging function setting value is zero, debugging may be performed without making program comparison. During the development of a program and during the debugging of a program, preferably, a debugging function setting value may be set to one, taking frequent use of debugging functions into consideration. Thereby, without determining whether parts of the program stored in blocks of the nonvolatile memory 203 match comparison data sent from the host PC 800, since debugging is performed on demand for debugging, time for program development and debugging operations can be reduced.

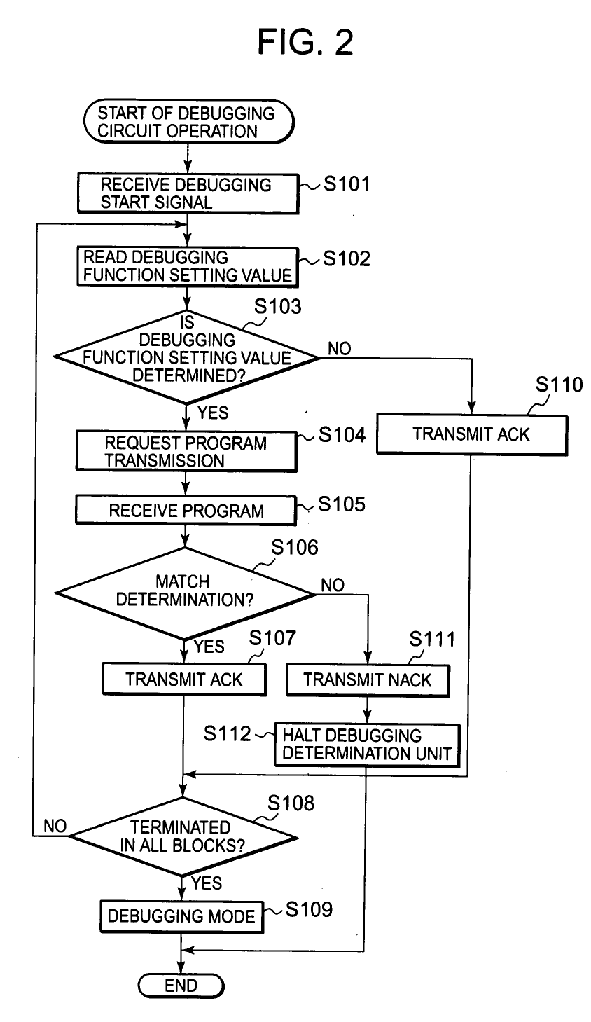

Next, an operation flow of the microcomputer 201 during program debugging is shown in FIG. 2. FIG. 2 is used to detail the operation of program debugging. First, the debugging determination unit 260 of the microcomputer 201 is connected to the host PC 800 via the debugging machine 600, and the host PC 800 transmits a debugging start signal. The debugging determination unit 260 receives the start signal (Step S101). Thereby, the debugging determination unit 260 operates. The debugging determination unit 260 reads a debugging function setting value stored in the memory for setting a debugging function 206 that corresponds to an arbitrary block of the nonvolatile memory 203 (Step S102), and determines whether the debugging function setting value of the memory for setting a debugging function 206 that corresponds to the block of the nonvolatile memory 203 is stored with a value zero or one (Step S103). Here, generally, a memory address, which is a number (address) indicative of a block of the memory that stores data is used. In the first embodiment, for example, whether program comparison is necessary is determined beginning with lower blocks having smaller memory addresses of the nonvolatile memory 203.

When a debugging function setting value that corresponds to an arbitrary block of the nonvolatile memory 203 is one, an ACK signal indicating that it is not determined whether parts of a program stored in blocks of the nonvolatile memory 203 match comparison data stored in the host PC 800 is transmitted to the host PC 800 via the debugging determination unit 260 (Step S110). Then, control proceeds to Step S108.

On the other hand, when a debugging function setting value that corresponds to an arbitrary block of the nonvolatile memory 203 is zero, parts of a program stored in the nonvolatile memory 203 is compared with comparison data that correspond to part of the program and is stored in the host PC 800. In this case, the debugging determination unit 206 requests transmitting the comparison data that corresponds parts of the program stored in the nonvolatile memory 203 and is stored in the host PC 800 (Step S104). The host PC 800 transmits the program for comparison stored in the host PC 800 to the debugging determination unit 260, and the debugging determination unit 260 receives the program for comparison (Step S105). The received program is temporarily stored in the RAM 204.

The debugging determination unit 260 determines whether the comparison data stored in the RAM 204 matches parts of the program stored in the nonvolatile memory 203 (Step S106). As a result of the determination, when parts of the program stored in the nonvolatile memory 203 do not match the comparison data stored in the host PC 800, since debugging is not approved, a NACK signal indicating debugging mode disapproval is transmitted to the host PC 800 (Step S111). The debugging operations are terminated after presenting an indication of debugging mode disapproval. That is, the debugging determination unit 260 is halted (Step S112).

On the other hand, In Step S106, as a result of determining whether parts of the program stored in the nonvolatile memory 203 match the comparison data, when the programs match, blocks of the nonvolatile memory 203 having been subjected to match determination are approved for debugging. That is, an ACK signal indicating debugging mode approval for the blocks of the nonvolatile memory 203 having been subjected to match determination is transmitted to the host PC 800 via the debugging determination unit 260 (Step S107). Then, control proceeds to Step S108.

In Step S108, in all blocks of the nonvolatile memory 203, the debugging determination unit 260 determines which of zero and one in the debugging function setting values corresponding to the blocks is stored in the memory for setting a debugging function 206. In all blocks of the nonvolatile memory 203, when Step S103 is not performed, also in the remaining blocks, it is necessary to read the values of the memory for setting a debugging function 206 that correspond to the blocks to determine whether to perform program match determination. That is, when Step S103 is not performed in all blocks of the nonvolatile memory 203, control is returned to Step S102 to read debugging function setting values of the memory for setting a debugging function 206 which correspond to blocks of the nonvolatile memory 203 and for which Step S103 is not performed. Steps following the readout of the debugging function setting values are the same as the above-described Steps S103 to S108, and Steps 110 to S112.

That is, in Step S103, in all blocks of the nonvolatile memory 203, the debugging determination unit 260 determines which of zero and one in the debugging function setting values corresponding to the blocks of the nonvolatile memory 203 is stored. As a result of the determination, when the debugging function setting value is one, the debugging determination unit 260 approves debugging of a part of the program stored in the relevant block, and proceeds to Step S108. On the other hand, when zero is stored in the memory for setting a debugging function 206, whether to approve debugging is determined. That is, it is determined whether a part of a program stored in a block of the nonvolatile memory 203 matches a part of the program which is stored in the host PC 800 and corresponds to the part of the program stored in the Nonvolatile memory 203. As a result of the determination, when they match, control proceeds to Step S108. On the other hand, when they do not match, the debugging is terminated.

In Step S108, when all the debugging function setting value stored in the memory for setting a debugging function 206 are one, or when the debugging function setting values corresponding to parts of the program stored in the blocks of the nonvolatile memory 203 are zero, only when the comparison data and all parts of the program stored in the nonvolatile memory 203 match, the debugging determination unit 206 approves debugging (Step S109).

In the first embodiment, in all blocks of the nonvolatile memory 203, the debugging function setting values are checked (Step S108). That is, in all blocks of the nonvolatile memory 203 (Areas 0 to 3), whether to approve debugging is determined based on debugging function setting values. However, for example, only a part (e.g., Area 1) of blocks of the nonvolatile memory 203 is checked for the approval or disapproval of debugging, and debugging is approved in the block, debugging may be performed. That is, instead of checking all debugging function setting values of Areas 0 to 3, only for Area 1, the debugging function setting value may be checked. As a result, a security canceling operation for debugging becomes less troublesome, and time for debugging operations is reduce. In the first embodiment, debugging function setting values (zero or one) corresponding to blocks of the nonvolatile memory 203 are stored in the memory for setting a debugging function 206. For example, a debugging function setting value is configured with four bits, and parts of a program stored in Area 0 when a debugging function setting is 0000 and Areas 1 to 3 when 1111 may be checked for the approval or disapproval of debugging, and other blocks may not be checked for the approval or disapproval of debugging. Furthermore, a debugging function setting value is configured with two bits, and Area 0 when the debugging function setting value is 00, and Areas 1 to 3 when 11 may be checked for the approval or disapproval of debugging, and other blocks may not be checked for the approval or disapproval of debugging.

As described above, the microcomputer 201 of the first embodiment includes the nonvolatile memory 203 configured with plural blocks, and the memory for setting a debugging function 206 that stores debugging function setting values corresponding to blocks of the nonvolatile memory 203. That is, one program is stored separately in units of blocks of the nonvolatile memory 203, and the memory for setting a debug function 206 that stores the debugging function setting values corresponding to blocks of the nonvolatile memory 203 is provided. Debugging function setting values (zero or one) corresponding to blocks of the nonvolatile memory 203 are stored in the memory for setting a debugging function. Thereby, whether to approve debugging can be determined for each of blocks of the nonvolatile memory 203, that is, for each of parts of a program.

For example, as debugging function setting values corresponding to blocks of the nonvolatile memory 203 in which program updating is performed, debugging function setting values indicating that program comparison is not performed are stored. As debugging function setting values corresponding to blocks of the nonvolatile memory 203 in which a program is not updated, debugging function setting values indicating that program comparison is performed are stored. Thereby, even when a program of the nonvolatile memory 203 is rewritten by program updating, the rewritten block of the nonvolatile memory 203 is debugged without being subjected to program match determination, and only blocks of the nonvolatile memory 203 in which program updating is not performed are subjected to program match determination. When programs match, the host PC 800 can perform debugging. That is, since whether to approve debugging can be determined for each of blocks of the nonvolatile memory 203, even when programming updating is performed, security canceling for starting debugging can be performed without troublesome operations. As a method for security assurance during debugging, since a program itself of a microcomputer is used as security code, the user has only to manage only the program, so that program management can be simplified.

### Second Embodiment

The following describes a second embodiment. Although the above-described first embodiment assumes that program updating is performed, when program updating is not performed, when program updating is not performed, for example, a nonvolatile memory may not be split into plural blocks. That is, a nonvolatile memory has only one block, and the whole program is stored in the block. When a user performs debugging, it is determined whether the whole program stored in the nonvolatile memory matches. The following details the configuration of a debugging system of a microcomputer of the second embodiment, and processes from program development to system shipment. Identical reference numerals are assigned to identical components in the first embodiment; detailed descriptions of them are omitted.

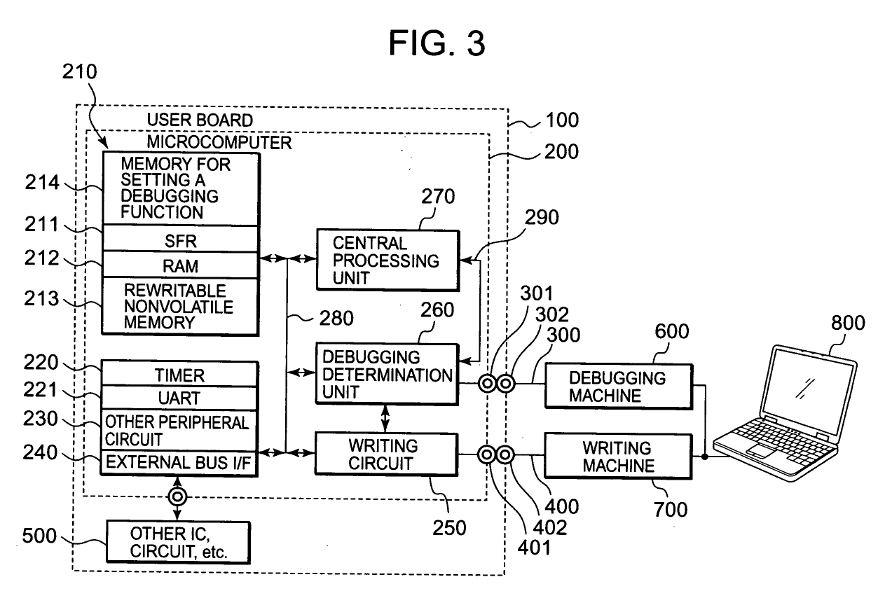

FIG. 3 shows an overall configuration of a debugging system of a microcomputer according to a second embodiment. As shown in FIG. 3, a debugging system of the microcomputer according to the second embodiment includes a user board 100 having a microcomputer 200 that includes a memory 210, a timer 220, UART 221, another peripheral circuit 230, an external bus IF 240, a writing circuit 250, a debugging determination unit 260, a CPU 270, and the like, and an IC 500, a debugging machine 600, a writing machine 700, and an EWS personal computer 800 (hereinafter referred to as a host PC) that performs program debugging, program writing, and the like. The debugging machine 600 is connected with the host PC 800 and the debugging determination unit 260. The writing machine 700 is connected with the host PC 800 and the writing circuit 250.

The memory 210 includes an SFR 211, a RAM 212, a nonvolatile memory 213, and a memory for setting a debugging function 214. The nonvolatile memory 213 is configured with one block in which the whole program of the microcomputer is stored.

The microcomputer 200 according to the second embodiment includes a memory for setting a debugging function 214 in which a debugging function setting value is stored. The debugging function setting value is a value indicating whether to approve debugging. For example, in the second embodiment, the memory for setting a debugging function 214 is configured with one bit, and is set to zero when it is determined whether a program stored in the host PC 800 matches a program stored in the nonvolatile memory 213 to determine whether to approve debugging. The debugging function setting value is set to one when debugging is approved without comparing a program stored in the host PC 800 with a program stored in the nonvolatile memory 213.

That is, as described later, a debugging start signal is transmitted to the debugging determination unit 260 from the host PC 800. The debugging determination unit 260, to determine whether to approve debugging, reads the debugging function setting value of the memory for setting a debugging function 214. When the debugging function setting value is one, debugging is approved without performing match determination. On the other hand, when the debugging function setting value is zero, a program stored in the host PC 800 compares with a program stored in the nonvolatile memory 213 to perform match determination. In match determination, debugging is approved when the whole program stored in the host PC 800 matches the whole program stored in the nonvolatile memory 213.

In the second embodiment, like the first embodiment, when a debugging function setting value stored in the memory for setting a debugging function 214 is zero, it is determined whether a program stored in the host PC 800 matches a program stored in the nonvolatile memory 213 to determine whether to approve debugging. When a debugging function setting value is one, debugging is approved without comparing a program stored in the host PC 800 with a program stored in the nonvolatile memory 213. However, when a debugging function setting value is one, program match determination may be performed, and when a debugging function setting value is zero, debugging may be performed without performing program match determination.

From the above, when one is stored in the memory for setting a debugging function 214, the host PC 800 performs debugging without the debugging determination unit 260 comparing a program stored in the nonvolatile memory 213 with a program sent from the host PC 800 via the debugging machine 600. On the other hand, when zero is stored in the memory for setting a debugging function 214, the debugging determination unit 206 compares a program stored in the nonvolatile memory 213 with a program sent from the host PC 800 via the debugging machine 600. When the both programs match wholly, the host PC 800 immediately performs debugging. As a result of the program comparison, when the both programs do not match, the host PC 800 does not perform debugging. That is, with the program itself used as security code for debugging, the program stored in the host PC 800 is compared with the program stored in the nonvolatile memory 213, and only when the both programs match, debugging can be performed.

It is desirable that the memory for setting a debugging function 214 is a rewritable memory. As described later, for example, in the stage of program development, a value is set so as to approve debugging without comparing a program stored in the host PC 800 with a program stored in the nonvolatile memory 213. On the other hand, when debugging is demanded, it is desirable that a value is set so as to approve debugging only when match is obtained as a result of program match determination. Therefore, it is desirable that the memory for setting a debugging function 214 is a rewritable memory.

The following describes processes of program development, program writing, and program debugging that are performed by a user by using the above-described microcomputer, and product shipment. First, program development is performed. That is, the user defines the operation of the microcomputer 200 to conform to a system created by the user. Then, the host PC 800 is used to perform coding (creation) of a program for the microcomputer.

Next, the coded program is written. The user transfers the coded program from the host PC 800 to the writing circuit 250 of the microcomputer 200 via the writing machine 700. The writing circuit 250 receives the program transmitted from the host PC 800, and writes the program sent from the host PC 800 to the nonvolatile memory 213 of the microcomputer 200. In the second embodiment, after elements such as the memory 210 and the debugging determination unit 260 are formed on the microcomputer 200, the program is written from the host PC 800 to the nonvolatile memory 213 via the writing machine 700 and the writing circuit 250. However, in the manufacturing process of the microcomputer 200, for example, the writing circuit may also be connected directly to the nonvolatile memory 213 to write a program without going through the host PC 800, and the like.

When a program is written to the nonvolatile memory 213, debugging function setting values stored in the memory for setting a debugging function 214 may be decided. That is, as described above, a debugging function setting value of one or zero is stored in the memory for setting a debugging function 214. During the program development and during the program debugging, since debugging functions are frequently used, preferably, a debugging function setting value of the memory for setting a debugging function 214 may be set to one. That is, during the program development and during the program debugging, without determining whether the program stored in the nonvolatile memory 213 matches a program sent from the host PC 800 via the debugging machine 600, it is desirable to immediately approve debugging on demand for debugging. Thereby, time for debugging operations can be shortened.

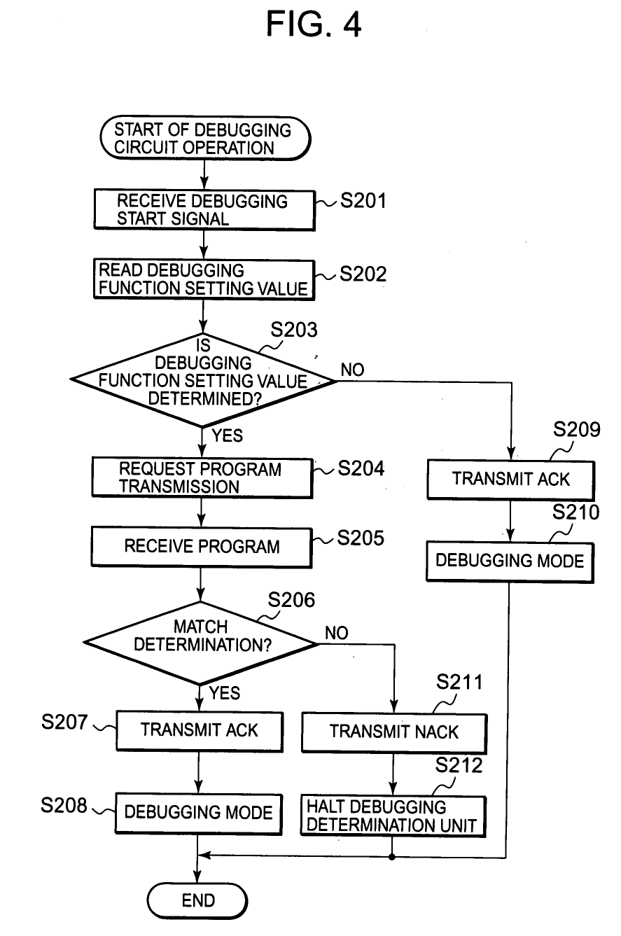

The following describes the debugging of the microcomputer 200. FIG. 4 shows an operation flow of the microcomputer 200 in debugging. First, the user connects the microcomputer 200 and the host PC 800 via the debugging machine 600. The user transmits a debugging start signal from the host PC 800. The debugging determination unit 260 of the microcomputer 200 receives a debugging start signal via the debugging machine 600 (Step S201).

On receiving the debugging start signal, the debugging determination unit 260 reads a debugging function setting value of the memory for setting a debugging function 214 (Step S202). It determines which of zero and one is stored in the memory for setting a debugging function 214 (Step S203). When one is stored in the memory for setting a debugging function 214, it transmits an ACK (Acknowledgement) signal indicating debug mode approval to the host PC 800 via the debugging machine 600 (Step S209), and the host PC 800 performs debugging (Step S210).

On the other hand, when zero is stored in the memory for setting a debugging function 214, the debugging determination unit 260 compares a program of nonvolatile memory 213 with a program stored in the host PC 800. In this case, the debugging determination unit 260 requests the transmission of the program stored in the host PC 800 via the debugging machine 600 (Step S204). On receiving the program transmission request from the debugging determination unit 260, the host PC 800 transmits the stored program to the debugging determination unit 260 of the microcomputer 200. The debugging determination unit 260 receives a program for comparison sent from the host PC 800 (Step S205). The received program is temporarily stored in the RAM 212.

Next, the debugging determination unit 260 determines whether the program for comparison stored in the RAM 212 matches the program stored in the nonvolatile memory 213 (Step S206). At this time, for example, when the program for comparison stored in the RAM 212 is too large to be held in the RAM 212, the program for comparison is stored in the RAM 212 separately several times. That is, first, data of a part of the program is stored in the RAM 212, data of parts having been compared is discarded, and remaining data is successively stored in the RAM 212 for comparison. When the debugging determination unit 260 of the microcomputer 200 has compared the program for comparison stored in the RAM 212 with the program stored in the nonvolatile memory 213, with the result that program contents match wholly, it transmits an ACK signal indicating debug mode approval to the host PC 800 (Step S207). When the host PC 800 receives the ACK signal indicating the debug mode approval, debugging is performed (Step S208).

On the other hand, in Step 106, when the program for comparison stored in the RAM 212 does not match the program stored in the nonvolatile memory 213, the debugging determination unit 260 transmits a NACK signal indicating debug mode disapproval to the host PC 800 (Step S211). It displays a message indicating debug mode disapproval to the user in the host PC 800 and terminates the debugging. That is, the debugging determination unit 260 is halted (Step S212), and the host PC 800 terminates processing of the host PC 800 without performing debugging.

The debugging determination unit 260 of the microcomputer 200, when the host PC 800 performs debugging (Steps S208 and S210), approves the reading of the program stored in the nonvolatile memory 213. That is, the program can be read. The user operates the host PC 800 to read the program stored in the nonvolatile memory 213 of the microcomputer 200, or perform debugging operations such as execution and modifications to modify the program. When the program has been modified, the modified program is stored in the host PC 800.

Thus, the debugging determination unit 260, when zero is stored in the memory for setting a debugging function 214, determines whether the program stored in the nonvolatile memory 213 of the microcomputer matches the program stored in the host PC 800. If the both programs do not match, debugging is not approved. On the other hand, when the both programs match, debugging is approved. When one is stored in the memory for setting a debugging function 214, the debugging determination unit 260 approves debugging without determining whether the program stored in the nonvolatile memory 213 matches the program stored in the host PC 800.

By using the debugging function setting value, for example, when debugging and writing are frequently repeated, to reduce time for comparison operations, one can set in the memory for setting a debugging function 214 to avoid comparison between the program stored in the nonvolatile memory 213 of the microcomputer 200 and the program stored in the host PC 800.

After program debugging has been performed, the user ships the system using the microcomputer 200. After shipment, when the system using the microcomputer becomes defective, as described above, the user transmits a debugging start signal from the host PC 800 to the debugging determination unit 260 of microcomputer 200 to perform debugging. Thereby, the user can analyze the failure of the microcomputer. By setting the memory for setting a debugging function 214 to zero, a third party not knowing the program can be prevented from illegally reading the nonvolatile memory 213 of the microcomputer 200. Furthermore, data indicating internal states of another memory SFR 211 and the CPU 270 of the microcomputer 290 can be prevented from leaking.

In the second embodiment, when program updating is performed, a setting value for debugging may be changed to one (without comparison) when the program is updated. By this construction, since the host PC 800 can approve debugging without determining whether a program stored in the nonvolatile memory 213 matches a program stored in the host PC 800, troublesome operations during security canceling for debugging are not involved. In this case, ID, password, and the like of related art are preferably used as security codes of the microcomputer 200.

As described above, in the second embodiment, a program itself of the microcomputer 200 is used as security code of the microcomputer 200. That is, when a program of the microcomputer 200 is debugged, a debugging function setting value of the memory for setting a debugging function 214 is read, according to the value, it is determined whether to compare the program stored in the nonvolatile memory 213 with a program stored in the host PC 800, whether to perform debugging is determined according to the determination result. When program comparison is not performed, the debugging determination unit 260 immediately approves debugging. When program comparison is performed, it determines whether the program stored in the host PC 800 matches the program stored in the nonvolatile memory 213. Only when the programs match, the debugging determination unit 260 approves debugging. On the other hand, when the programs do not match as a result of the program comparison, the debugging determination unit 260 does not approve debugging. That is, by using the program of the microcomputer 200 as security code, since the user has only to manage only programs, program management can be simplified. The program of the microcomputer 200 can be prevented from leaking to third parties not knowing the program. When program updating has been performed, by setting a debugging function setting value so as not to perform program comparison, security canceling for starting debugging can be performed without performing troublesome operations.

It goes without saying that the present invention is not limited to the above-mentioned embodiments, and may be modified in various ways without departing from the scope and spirit of the present invention. For example, the first embodiment and the second embodiment may be combined. That is, the microcomputer may have the functions of the first embodiment and the second embodiment. For example, until program updating is performed, the second embodiment is used to compare the whole of programs. After program updating has been performed, the first embodiment may be used to compare program parts stored in blocks of the nonvolatile memory with parts of a program stored in the host PC.

Further, it is noted that, Applicant's intent is to encompass equivalents of all claim elements, even if amended later during prosecution

What is claimed is:

1. A microcomputer, comprising:
a debugging terminal which is connectable to a debugging machine used to debug a program;
a memory which stores plural debugging function setting values each associated with each of plural storage areas to set a debugging function; and
a debugging determination unit that compares a part of said program stored in a storage area selected based on said debugging function setting values, with data inputted from said debugging terminal, and based on a result of comparison, determines whether to approve external access.

2. The microcomputer of claim 1,
wherein said debugging determination unit approves said access when said part of said program is determined to match the inputted data.

3. The microcomputer of claim 2,
wherein, when said debugging function setting value is a first value, said debugging determination unit approves said debugging based on match determination, and when said debugging function setting value is a second value, said debugging determination unit approves said debugging without performing the match determination.

4. The microcomputer of claim 3,
wherein said part of said program is rewritten by a central processing unit, and
wherein said debugging function setting value corresponding to the rewritten part of said program, is set to said second value.

5. The microcomputer of claim 1,
wherein said debugging determination unit compares a part of said program stored in respective ones of said plural storage areas, with said data inputted from said debugging terminal, and determines whether to approve external access, based on a result of comparison.

6. A debugging system, comprising:
a microcomputer according to claim 1; and
said debugging machine that performs debugging of said microcomputer.

7. A debugging method of a microcomputer, comprising:
checking a memory to determine which of a first data or a second data is stored therein;
accepting to perform a debug of said microcomputer, without checking a program stored in a different memory to operate said microcomputer and a bit inputted from outside of said microcomputer, when said first data is determined to be stored; and
conducting a check of said program and said bit, when said second data is determined to be stored.

8. The debugging method claim 7, further comprising:
approving to perform debugging when said program indicates that a part of said program matches said bit.

9. The debugging method of claim 8,
wherein said check is conducted by a debugging determination unit.

10. The debugging method of claim 9,
wherein said first data is stored in said memory for a central processing unit to rewrite said part of said program.

11. The debugging method of claim 9,
wherein said debugging determination unit compares a part of said program stored in respective ones of a plurality of storage areas in the different memory, with said bit.

12. A microcomputer, comprising:
a first memory which stores a program to operate said microcomputer; and
a second memory which stores one of a first data and a second data, said first data indicating approval to perform a debug of said microcomputer without checking said program and a bit inputted from outside of said microcomputer, said second data indicating approval to perform said debug based on a check of said program and said bit.

13. The microcomputer as claimed in claim 12, wherein:
said first memory comprises a plurality of memory areas each storing a part of said program; and
said second memory comprises a plurality of memory portions corresponding to said memory areas, respectively, each of said memory portions storing one of said first and second data.

14. The microcomputer as claimed in claim 13, wherein:
each of said first and second data comprises four bit or less.

15. The microcomputer as claimed in claim 14, wherein:
each of said first and second data comprises a single bit.

16. The microcomputer as claimed in claim 15, further comprising:
a debugging determination unit which compares said program with said bit.

17. The microcomputer as claimed in claim 16, wherein:
said debugging determination unit approves to perform a debug said program when comparison results indicate that said program matches with said bit.

18. The microcomputer as claimed in claim 17, further comprising:
a write circuit which writes a modification program into said first memory.
